(19) United States
(12) Patent Application Publication
(10) Pub. No.: US 2025/0078107 A1
(43) Pub. Date: Mar. 6, 2025

(54) REWARD APPARATUS AND METHOD FOR BLOCKCHAIN-BASED RECONFIGURABLE INTELLIGENT SURFACE INFRASTRUCTURES SHARING

(71) Applicant: ELECTRONICS AND TELECOMMUNICATIONS RESEARCH INSTITUTE, Daejeon (KR)

(72) Inventors: Cheol-Hee PARK, Daejeon (KR); Jong-Hyun KIM, Daejeon (KR); Kyung-Min PARK, Daejeon (KR); Ji-Hyeon SONG, Daejeon (KR)

(73) Assignee: ELECTRONICS AND TELECOMMUNICATIONS RESEARCH INSTITUTE, Daejeon (KR)

(21) Appl. No.: 18/408,765

(22) Filed: Jan. 10, 2024

(30) Foreign Application Priority Data
Sep. 5, 2023 (KR) 10-2023-0117466

(51) Int. Cl. G06Q 30/0207

(52) U.S. Cl. CPC G06Q 30/0207

(57) ABSTRACT

Disclosed herein are a reward apparatus and method for blockchain-based blockchain-based Reconfigurable Intelligent Surface (RIS) infrastructure sharing. The reward apparatus for blockchain-based RIS infrastructure sharing may provide a service to a service user terminal through an RIS node, verify a contribution of the RIS node to provision of the service quantified by the RIS node using a first blockchain network, and provide a reward to the RIS node depending on the contribution.

### CROSS REFERENCE TO RELATED APPLICATION

This application claims the benefit of Korean Patent Application No. 10-2023-0117466, filed Sep. 5, 2023, which is hereby incorporated by reference in its entirety into this application.

### BACKGROUND OF THE INVENTION

### 1. Technical Field

The present disclosure relates generally to reconfigurable intelligent surface (RIS) and block chain technology, and more particularly to technology for providing suitable rewards for contribution to the quality improvement of a mobile communication network to infrastructure owners who share infrastructures for RIS based on a blockchain.

### 2. Description of the Related Art

Reconfigurable Intelligent Surface (RIS) technology is similar to a conventional Multiple Input, Multiple Output (MIMO) relay in terms of expand the range or coverage of wireless signals. However, the MIMO relay employs an active scheme of receiving and retransmitting a signal, whereas RIS employs sa passive scheme of reflecting/transmitting/refracting signal itself. It is anticipated that multiple RIS devices are to be installed in a nearby region so as to expand the coverage of mobile communication in the sixth generation (6G) era in which RIS is expected to be commercialized, due to the fact that RIS technology is more cost-effective than a relay scheme using antennas and the prototypes of RIS devices currently under search adopt a planar shape.

The characteristics of a mobile communication network configured by RIS are in that a mobile communication network up to 5G is configured to construct infrastructures only by a telecommunication service provider (Telco), whereas, in the 6G era in which RIS is expected to be introduced, RIS is attached to infrastructures possessed by public or private entities, thus allowing various infrastructure owners, in addition to the Telco, to contribute to the construction of infrastructures of a mobile communication network. Up to date, systems and methods for quantifying the contribution of a mobile communication network to be completed through collaboration between telecommunication network service providers and infrastructure providers for RIS and providing suitable rewards corresponding to the quantified contribution have not yet been presented.

Further, in a contribution-reward model which quantifies contributions to service provision and provides rewards corresponding thereto in a specific application environment, the transparency and reliability of reward provision may be deteriorated when the number of participants increases and contribution activities and service usage are distributed and complicated. In this way, the activity and contribution of each participant may be recorded and may be shared among all participants by applying a blockchain system in a complicated and distributed service operating environment, thus securing reliability. In particular, a contributor may record details of contributing activities on a blockchain and a service provider may provide rewards based on corresponding contribution details. Here, because the contributor cannot randomly manipulate the contribution activities and the degrees thereof to be recorded on the blockchain, and the service provider cannot maliciously manipulate the fairness of rewards, the blockchain system may provide rewards with higher reliability in a distributed environment having complicated activities.

Meanwhile, Korean Patent Application Publication No. 10-2023-0057219 entitled “Method and apparatus for RIS automatic setup” discloses a method and apparatus which can perform efficient communication between a base station and a terminal using RIS in a wireless communication system.

### SUMMARY OF THE INVENTION

Accordingly, the present disclosure has been made keeping in mind the above problems occurring in the prior art, and an object of the present disclosure is to quantitatively assess the contribution of an RIS infrastructure provider and provide a reasonable reward corresponding to the assessed contribution, in a mobile communication network to be completed with RIS.

Another object of the present disclosure is to support revenue (profit) distribution to Telcos or third-party service providers contributing to a revenue model which will newly emerge in the 6G era due to RIS.

In accordance with an aspect of the present disclosure to accomplish the above objects, there is provided a reward apparatus for blockchain-based Reconfigurable Intelligent Surface (RIS) infrastructure sharing, including one or more processors and memory configured to store at least one program that is executed by the one or more processors, wherein the at least one program is configured to provide a service to a service user terminal through an RIS node, verify a contribution of the RIS node to provision of the service quantified by the RIS node using a first blockchain network, and provide a reward to the RIS node depending on the contribution.

The RIS node may calculate the contribution by quantifying usage of RIS resources based on quality of a wireless signal for the service and a service usage time, which are received from the service user terminal.

The at least one program may be configured to record the quality of the wireless signal for the service and the service usage time, which are received from the service user terminal, on the first blockchain network and to verify the contribution based on the quality of the wireless signal and the service usage time, recorded on the first blockchain network.

The at least one program may be configured to request the RIS node to perform a task of an RIS device in compliance with instructions of a telecommunication service provider regarding the service.

The RIS node may calculate the contribution by quantifying task details of the RIS device related to the instructions of the telecommunication service provider regarding the service.

The at least one program may be configured to record the instructions of the telecommunication service provider regarding the service on the first blockchain network and verify the contribution based on the instructions of the telecommunication service provider regarding the service, recorded on the first blockchain network.

The service user terminal may quantify service provision details for the task details of the RIS device, record the quantified service provision details on the first blockchain network, and verifies the contribution based on the service provision details recorded on the first blockchain network.

The RIS device may record the reward on a second blockchain network and allow the reward to be verified through RIS nodes participating in the second blockchain network.

The first blockchain network may verify a first blockchain transaction related to the contribution, and the second blockchain network may verify a second blockchain transaction related to the reward.

The first blockchain transaction may be processed based on a first consensus algorithm of the first blockchain network to which the telecommunication service provider belongs, and the second blockchain transaction may be processed based on a second consensus algorithm of the second blockchain network to which the RIS node belongs.

In accordance with another aspect of the present disclosure to accomplish the above objects, there is provided a reward method for blockchain-based Reconfigurable Intelligent Surface (RIS) infrastructure sharing, the reward method being performed by a reward apparatus for blockchain-based RIS infrastructure sharing, the reward method including providing a service to a service user terminal through an RIS node, verifying a contribution of the RIS node to provision of the service quantified by the RIS node using a first blockchain network, and providing a reward to the RIS node depending on the contribution.

Verifying the contribution may include calculating, by the RIS node, the contribution by quantifying usage of RIS resources based on quality of a wireless signal for the service and a service usage time, which are received from the service user terminal.

Verifying the contribution may further include recording the quality of the wireless signal for the service and the service usage time, which are received from the service user terminal, on the first blockchain network and verifying the contribution based on the quality of the wireless signal and the service usage time, recorded on the first blockchain network.

Verifying the contribution may include requesting the RIS node to perform a task of an RIS device in compliance with instructions of a telecommunication service provider regarding the service.

Verifying the contribution may further include calculating, by the RIS node, the contribution by quantifying task details of the RIS device related to the instructions of the telecommunication service provider regarding the service.

Verifying the contribution may further include recording the instructions of the telecommunication service provider regarding the service on the first blockchain network and verifying the contribution based on the instructions of the telecommunication service provider regarding the service, recorded on the first blockchain network.

Verifying the contribution may further include quantifying, by the service user terminal, service provision details for the task details of the RIS device, recording the quantified service provision details on the first blockchain network, and verifying the contribution based on the service provision details recorded on the first blockchain network.

Providing the reward may include recording, by the RIS device, the reward on a second blockchain network and allowing the reward to be verified through RIS nodes participating in the second blockchain network.

The first blockchain network may verify a first blockchain transaction related to the contribution, and the second blockchain network may verify a second blockchain transaction related to the reward.

The first blockchain transaction may be processed based on a first consensus algorithm of the first blockchain network to which the telecommunication service provider belongs, and the second blockchain transaction may be processed based on a second consensus algorithm of the second blockchain network to which the RIS node belongs.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating an RIS operating environment according to an embodiment of the present disclosure;

FIG. 2 is a diagram illustrating a reward system for blockchain-based RIS infrastructure sharing according to an embodiment;

FIG. 3 is an operation flowchart illustrating a reward method for blockchain-based RIS infrastructure sharing according to an embodiment;

FIG. 4 is an operation flowchart illustrating an example of the contribution quantification step illustrated in FIG. 3; and

FIG. 5 is a diagram illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present disclosure will be described in detail with the attached drawings.

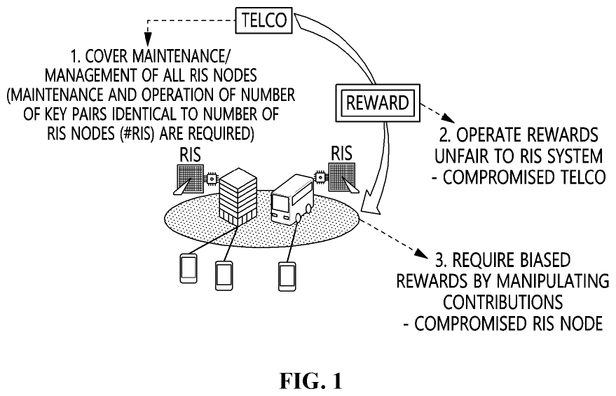

FIG. 1 is a diagram illustrating problems occurring in an RIS operating environment according to an embodiment of the present disclosure.

Referring to FIG. 1, Reconfigurable Intelligent Surface (RIS) technology is technology that is capable of flexibly expanding mobile communication coverage by reflecting, transmitting or refracting a signal. An RIS may be deployed and utilized as an essential element in a next generation mobile communication environment. The RIS is a planar electronic device, and scenarios for the RIS are presented in such a way that the RIS is installed in outdoor facilities or devices, owned by public or private entities. The RIS may improve the service quality of wireless communication by controlling wireless (radio) signals. Here, each RIS node may store the activity of controlling the wireless signals in a local device (i.e., a computing node) associated with the corresponding RIS node, and a telecommunication service provider (Telco) may finally verify the contribution of each RIS node.

Further, in a large-scale infrastructure system, such as a mobile communication system, a distribution system, or a social network service, the entire ecosystem is formed through the activities of various entities, such as a service manager or a user, as well as a service provider, and the usage of the corresponding service. Here, in order to maintain a service ecosystem, the contribution of participants (i.e., simple service users and other participants) is essential. For example, telecommunication service providers who provide mobile communication services (i.e., mobile carriers) may maintain service quality by installing relay stations in areas in which the strengths of radio signals are expected to be weakened. Here, each of the telecommunication service providers pays a certain reward to each provider (a building owner or the like) who provides the corresponding space (space in which relay stations are installed. In this way, in case where a service provider enables the management of a contributor and a contribution activity, a contribution-reward model can be clearly defined. However, when contributing entities are dispersed over a wide area to increase a service management area, or when complexity is present in contribution activities, defining a contribution-reward model may become a very difficult issue.

In particular, as described above, the RIS, which will be essentially utilized in future mobile communication systems, is expected to be subdivided and deployed extensively across a wide area. A problem arises in that, considering RIS node operation scenarios, it is impossible to realize the definition of centralized contribution-reward modeling for the RIS from the standpoint of deployment/management, reliability, etc. Furthermore, it may be unrealistic for a telecommunication service provider to independently secure RIS operators in terms of cost and efficiency in a future mobile communication system with which the RIS is to be associated. For example, when the operating rate of some RIS is decreased in the case where the telecommunication service provider pays a certain expense and deploys RISs, the telecommunication service provider may suffer a loss. A scheme for predicting radio wave intensities for respective areas to solve this problem and deploying RISs in consideration of the predicted radio wave intensities may be used, but this scheme may be unrealistic in a future mobile communication environment in which frequency is expected to be increased. Furthermore, there is a risk that RIS operators will unfairly request rewards by manipulating the contributions of their own RISs and telecommunication service providers will maliciously manipulate rewards. For this, there is a need to newly define a highly-reliably contribution-reward model based on the contributions of participants.

Therefore, a reward apparatus and method for blockchain-based RIS infrastructure sharing according to embodiments of the present disclosure are intended to bear maintenance and management occurring in all RIS nodes and rightfully provide rewards, which are unfair, to the RIS system.

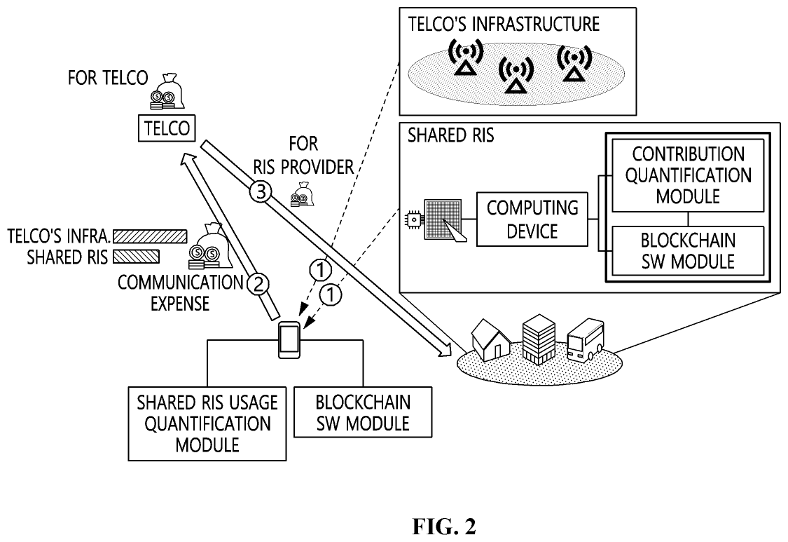

FIG. 2 is a diagram illustrating a reward system for blockchain-based RIS infrastructure sharing according to an embodiment.

Referring to FIG. 2, a reward system for blockchain-based RIS infrastructure sharing according to an embodiment of the present disclosure may include a reward apparatus for blockchain-based RIS infrastructure sharing corresponding to a telecommunication service provider server, a service user terminal, and RIS nodes.

The reward apparatus for blockchain-based RIS infrastructure sharing may quantify the contribution of each RIS node to the quality of a mobile communication network.

In particular, the reward system for blockchain-based RIS infrastructure sharing according to an embodiment of the present disclosure may provide a scheme for quantifying the contribution of a specific RIS node and verifying the quantified contribution based on a real-time feedback mechanism, executed among a mobile carrier, an RIS operator, and a mobile communication user, and a blockchain system.

In this case, the reward apparatus for blockchain-based RIS infrastructure sharing may provide a service to the service user terminal through the RIS node, and may verify the contribution to the provision of the service quantified by the RIS node using the blockchain network.

Here, the reward apparatus for blockchain-based RIS infrastructure sharing may correspond to a telecommunication service provider server.

First, when a service request is received from the service user terminal (mobile device or the like), the telecommunication service provider server may provide the service to the service user terminal.

Here, when the RIS is taken into consideration in a service provision path, the telecommunication service provider server may provide the service to the RIS node.

The RIS node may deliver the corresponding service to the service user terminal.

Here, the service may be provided in the form of a wireless signal (radio wave) in the mobile communication environment.

The service user terminal which initially receives the service may transmit (reporting/feedback) the measured quality of the wireless signal to the RIS node and to the telecommunication service provider server.

The RIS node may receive the quality of the wireless signal from the service user terminal (if necessary) in response to the request of the telecommunication service provider server, may adjust the RIS to improve the service quality, and may quantify the usage of RIS resources.

Here, the RIS node may calculate the contribution by quantifying the RIS resource usage based on the quality of the wireless signal for the service and a service usage time, which are received from the service user terminal.

Here, the RIS node may request the telecommunication service provider server to verify the calculated contribution.

Here, the telecommunication service provider server and the service user terminal may verify the contribution of the RIS node.

The telecommunication service provider server may record the quality of the wireless signal for the service and the service usage time, transmitted from the service user terminal, on the blockchain network so as to verify the contribution of the RIS node.

The telecommunication service provider server may record the quality of the wireless signal for the service and the service usage time, which are received from the service user terminal, on the blockchain network, and may verify the contribution based on the wireless signal quality and the service usage time recorded on the blockchain network.

Further, the telecommunication service provider server may request the RIS node to perform the task of an RIS device in compliance with the instructions of the telecommunication service provider regarding the service.

Here, the RIS node may quantify the task details of the RIS device corresponding to the instructions of the telecommunication service provider regarding the service in relation to the service and then calculate the contribution of the RIS node.

Here, the RIS node may perform quantification of the contribution and the generation and operation of blocks through a computing device connected to the RIS node.

Here, the telecommunication service provider server may record, on the blockchain network, the instructions of the telecommunication service provider regarding the service, and may verify the contribution based on the instructions of the telecommunication service provider regarding the service recorded on the blockchain network.

Here, the service user terminal may quantify the details of provision of the service through the RIS node and may record the quantified details on the blockchain network.

Here, the service user terminal may verify the contribution based on the service provision details recorded on the blockchain network.

Here, the contribution calculated from the RIS resource usage and the contribution calculated from the task details of the RIS device may be summed.

Here, quantification of the operation details of the RIS device, the instructions of the telecommunication service provider, and details of the service received by the service user terminal may be implemented based on various schemes depending on the values of types of predefined operation details, instructions and service details.

Here, the telecommunication service provider server may repeat the above-described process until the service requested by the service user terminal is completed (terminated).

In this way, the contribution of each RIS node cannot be maliciously manipulated through blockchain recording and verification among three parities.

Further, the reward apparatus for blockchain-based RIS infrastructure sharing may distribute rewards depending on the contributions of respective RIS nodes.

The reward apparatus for blockchain-based RIS infrastructure sharing may provide rewards to the RIS nodes depending on the verified contributions of the RIS nodes.

Here, the owner of an infrastructure in which each RIS node is installed (i.e., an RIS owner) may acquire a reward provided to the corresponding RIS node.

In particular, the reward apparatus for blockchain-based RIS infrastructure sharing may provide a highly-reliable reward scheme in a distributed RIS environment having high complexity based on a blockchain and cryptocurrency system.

Here, the telecommunication service provider server may efficiently construct a mobile communication infrastructure by encouraging RIS deployment in the form of voluntary participation, and the RIS nodes may construct a new business model that is capable of obtaining rewards depending on the contributions.

Here, the telecommunication service provider server may provide rewards depending on the contributions to service quality to multiple RIS nodes (blockchain nodes) based on the blockchain network in a mobile communication environment in which RIS is operated.

In this case, the RIS nodes may record the rewards thereof on the blockchain network in which multiple RIS nodes (blockchain nodes) participate.

Here, the rewards may be provided based on cryptocurrency associated with the corresponding blockchain network, and blocks corresponding to reward details may be verified by RIS nodes.

Therefore, the telecommunication service provider server cannot maliciously manipulate the levels of rewards to be rightfully provided to the RIS nodes.

The blockchain network may include a first blockchain network which verifies a first blockchain transaction related to the contributions, and a second blockchain network which verifies a second blockchain transaction related to the rewards.

The blockchain transaction related to the contributions may be configured to process the calculation of the quantified contributions and the provision of rewards through the blockchain transactions.

Further, each blockchain transaction may be processed by a consensus mechanism corresponding to each group.

The first blockchain transaction may be processed based on a first consensus algorithm between blockchain nodes (i.e., the telecommunication service provider server and the service user terminal) belonging to the first blockchain network.

The second blockchain transaction may be processed based on a second consensus algorithm between blockchain nodes (RIS nodes) belonging to the second blockchain network.

Here, the consensus algorithm in the first blockchain network and the consensus algorithm in the second blockchain network may be processed in parallel, but the provision of rewards may be performed only when the two consensus processes have normally passed.

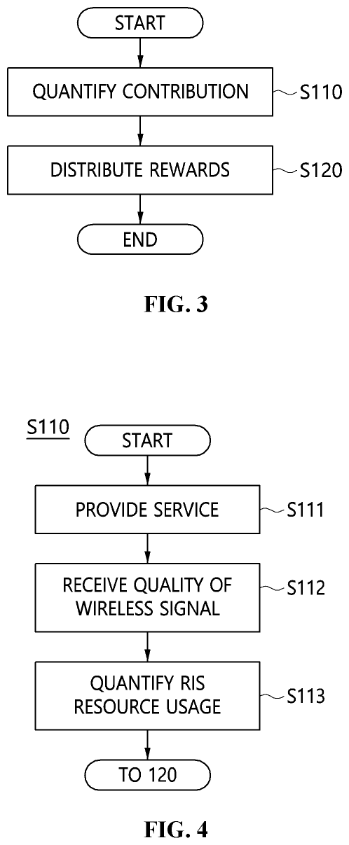

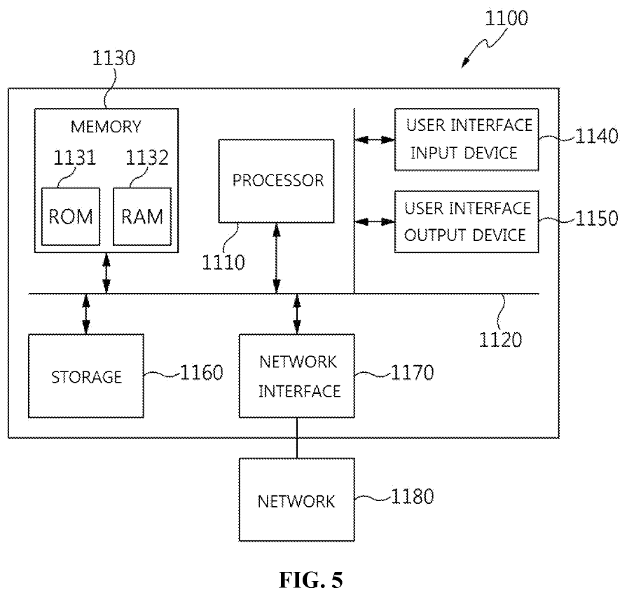

FIG. 3 is an operation flowchart illustrating a reward method for blockchain-based RIS infrastructure sharing according to an embodiment. FIG. 4 is an operation flowchart illustrating an example of the contribution quantification step illustrated in FIG. 3. FIG. 5 is an operation flowchart illustrating an example of the reward distribution step illustrated in FIG. 3.

Referring to FIG. 3, a reward apparatus for blockchain-based RIS infrastructure sharing may quantify the contribution of each RIS node to the quality of a mobile communication network at step S110.

That is, at step S110, a reward apparatus for blockchain-based RIS infrastructure sharing may provide a service to a service user terminal through the RIS node, and may verify the quantified contribution of the RIS node to the provision of the service using a blockchain network.

In particular, a reward system for blockchain-based RIS infrastructure sharing according to an embodiment of the present disclosure may provide a scheme for quantifying the contribution of a specific RIS node and verifying the quantified contribution based on a real-time feedback mechanism, executed among a mobile carrier, an RIS operator, and a mobile communication user, and a blockchain system.

Here, the reward apparatus for blockchain-based RIS infrastructure sharing may correspond to a telecommunication service provider server.

Referring to FIG. 4, in a procedure at step S110, when a service request is received from the service user terminal (mobile device or the like), the telecommunication service provider server may provide the service to the service user terminal at step S111.

Here, at step S111, when the RIS is taken into consideration in a service provision path, the telecommunication service provider server may provide the service to the RIS node.

The RIS node may deliver the corresponding service to the service user terminal.

Here, the service may be provided in the form of a wireless signal (radio wave) in the mobile communication environment.

Further, in the procedure at step S110, the telecommunication service provider server and the RIS node may receive information about the quality of a wireless signal from the service user terminal at step S112.

That is, at step S112, the service user terminal which initially receives the service may transmit (reporting/feedback) the measured quality of the wireless signal to the RIS node and to the telecommunication service provider server.

Here, at step S112, the RIS node may receive the quality of the wireless signal from the service user terminal (if necessary) in response to the request of the telecommunication service provider, and may adjust the RIS to improve the service quality.

Next, in the procedure at step S110, the RIS node may quantify the usage of RIS resources at step S113.

That is, at step S113, the RIS node may calculate the contribution by quantifying the RIS resource usage based on the quality of the wireless signal for the service and a service usage time, which are received from the service user terminal.

Here, at step S113, the RIS node may request the telecommunication service provider server to verify the calculated contribution.

Here, at step S113, the telecommunication service provider server and the service user terminal may verify the contribution of the RIS node.

Here, at step S113, the telecommunication service provider server may record the quality of the wireless signal for the service and the service usage time, transmitted from the service user terminal, on the blockchain network so as to verify the contribution of the RIS node.

Here, at step S113, the telecommunication service provider server may record the quality of the wireless signal for the service and the service usage time, received from the service user terminal, on the blockchain network, and may verify the contribution based on the wireless signal quality and the service usage time recorded on the blockchain network.

Here, at step S113, the telecommunication service provider server may request the RIS node to perform the task of an RIS device in compliance with the instructions of the telecommunication service provider regarding the service.

Here, at step S113, the RIS node may quantify the task details of the RIS device corresponding to the instructions of the telecommunication service provider regarding the service in relation to the service and then calculate the contribution of the RIS node.

Here, at step S113, the RIS node may perform quantification of the contribution and the generation and operation of blocks through a computing device connected to the RIS node.

Here, at step S113, the telecommunication service provider server may record, on the blockchain network, the instructions of the telecommunication service provider regarding the service, and may verify the contribution based on the instructions of the telecommunication service provider regarding the service recorded on the blockchain network.

Here, at step S113, the service user terminal may quantify the details of provision of the service through the RIS node and may record the quantified details on the blockchain network.

Here, at step S113, the service user terminal may verify the contribution based on the service provision details recorded on the blockchain network.

Here, the contribution calculated from the RIS resource usage and the contribution calculated from the task details of the RIS device may be summed.

Here, quantification of the operation details of the RIS device, the instructions of the telecommunication service provider, and details of the service received by the service user terminal may be implemented based on various schemes depending on the values of types of predefined operation details, instructions and service details.

Here, at step S113, the telecommunication service provider server may repeat the above-described process until the service requested by the service user terminal is completed (terminated).

In this way, the contribution of each RIS node cannot be maliciously manipulated through blockchain recording and verification among three parities.

Furthermore, the reward method for blockchain-based RIS infrastructure sharing according to an embodiment of the present disclosure may distribute rewards depending on the contributions of the RIS nodes at step S120.

That is, at step S120, rewards may be provided to the RIS nodes depending on the contributions of the RIS nodes recorded on the blockchain network.

Here, the owner of an infrastructure in which each RIS node is installed (i.e., an RIS owner) may acquire a reward provided to the corresponding RIS node.

In particular, at step S120, a highly reliable reward scheme may be provided in a distributed RIS environment having high complexity based on a blockchain and cryptocurrency system.

Here, the telecommunication service provider server may efficiently construct a mobile communication infrastructure by encouraging RIS deployment in the form of voluntary participation, and the RIS nodes may construct a new business model that is capable of obtaining rewards depending on the contributions.

Here, at step S120, the telecommunication service provider server may provide rewards depending on the contributions to service quality to multiple RIS nodes (blockchain nodes) based on the blockchain network in a mobile communication environment in which RIS is operated.

In this case, at step S120, the RIS node may record the rewards thereof on the blockchain network in which multiple RIS nodes (blockchain nodes) participate.

Here, the rewards may be provided based on cryptocurrency associated with the corresponding blockchain network, and blocks corresponding to reward details may be verified by RIS nodes.

Therefore, the telecommunication service provider server cannot maliciously manipulate the levels of rewards to be rightfully provided to the RIS nodes.

The blockchain network may include a first blockchain network which verifies a blockchain transaction related to the contributions, and a second blockchain network, which verifies a blockchain transaction related to rewards.

The blockchain transaction related to the contributions may be configured to process the calculation of the quantified contributions and the provision of rewards through the blockchain transactions.

Further, each blockchain transaction may be processed by a consensus mechanism corresponding to each group.

The first blockchain transaction may be processed based on a first consensus algorithm between blockchain nodes (i.e., the telecommunication service provider server and the service user terminal) belonging to the first blockchain network.

The second blockchain transaction may be processed based on a second consensus algorithm between blockchain nodes (RIS nodes) belonging to the second blockchain network.

Here, the consensus algorithm in the first blockchain network and the consensus algorithm in the second blockchain network may be processed in parallel, but the provision of rewards may be performed only when the two consensus processes have normally passed.

FIG. 5 is a diagram illustrating a computer system according to an embodiment of the present disclosure.

Referring to FIG. 5, each of a reward apparatus for blockchain-based RIS infrastructure sharing (telecommunication service provider server), an RIS node, and a service user terminal according to embodiments of the present disclosure may be implemented in a computer system 1100 such as a computer-readable storage medium. As illustrated in FIG. 5, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A reward apparatus for blockchain-based RIS infrastructure sharing according to an embodiment of the present disclosure may include one or more processors 1110 and memory 1130 configured to store at least one program that is executed by the one or more processors 1110, wherein the at least one program is configured to provide a service to a service user terminal through an RIS node, verify a contribution of the RIS node to provision of the service quantified by the RIS node using a first blockchain network, and provide a reward to the RIS node depending on the contribution.

Here, the RIS node may calculate the contribution by quantifying usage of RIS resources based on quality of a wireless signal for the service and a service usage time, which are received from the service user terminal.

Here, the at least one program may be configured to record the quality of the wireless signal for the service and the service usage time, which are received from the service user terminal, on the first blockchain network and to verify the contribution based on the quality of the wireless signal and the service usage time, recorded on the first blockchain network.

Here, the at least one program may be configured to request the RIS node to perform a task of an RIS device in compliance with instructions of a telecommunication service provider regarding the service.

Here, the RIS node may calculate the contribution by quantifying task details of the RIS device related to the instructions of the telecommunication service provider regarding the service.

Here, the at least one program may be configured to record the instructions of the telecommunication service provider regarding the service on the first blockchain network and verify the contribution based on the instructions of the telecommunication service provider regarding the service, recorded on the first blockchain network.

Here, the service user terminal may quantify service provision details for the task details of the RIS device, record the quantified service provision details on the first blockchain network, and verifies the contribution based on the service provision details recorded on the first blockchain network.

Here, the RIS device may record the reward on a second blockchain network and allow the reward to be verified through RIS nodes participating in the second blockchain network.

Here, the first blockchain network may verify a first blockchain transaction related to the contribution, and the second blockchain network may verify a second blockchain transaction related to the reward.

Here, the first blockchain transaction may be processed based on a first consensus algorithm of the first blockchain network to which the telecommunication service provider belongs, and the second blockchain transaction may be processed based on a second consensus algorithm of the second blockchain network to which the RIS node belongs.

The present disclosure may quantitatively assess the contribution of an RIS infrastructure provider and provide a reasonable reward corresponding to the assessed contribution in a mobile communication network to be completed with RIS.

The present disclosure may support revenue (profit) distribution to Telcos or third-party service providers contributing to a revenue model which will newly emerge in the 6G era due to RIS.

As described above, in the reward apparatus and method for blockchain-based RIS infrastructure sharing according to the present disclosure, the configurations and schemes in the above-described embodiments are not limitedly applied, and some or all of the above embodiments can be selectively combined and configured so that various modifications are possible.

What is claimed is:

1. A reward apparatus for blockchain-based Reconfigurable Intelligent Surface (RIS) infrastructure sharing, comprising:
one or more processors; and
a memory configured to store at least one program that is executed by the one or more processors,
wherein the at least one program is configured to:
provide a service to a service user terminal through an RIS node,
verify a contribution of the RIS node to provision of the service quantified by the RIS node using a first blockchain network, and
provide a reward to the RIS node depending on the contribution.

2. The reward apparatus of claim 1, wherein the RIS node calculates the contribution by quantifying usage of RIS resources based on quality of a wireless signal for the service and a service usage time, which are received from the service user terminal.

3. The reward apparatus of claim 2, wherein the at least one program is configured to record the quality of the wireless signal for the service and the service usage time, which are received from the service user terminal, on the first blockchain network and to verify the contribution based on the quality of the wireless signal and the service usage time, recorded on the first blockchain network.

4. The reward apparatus of claim 1, wherein the at least one program is configured to request the RIS node to perform a task of an RIS device in compliance with instructions of a telecommunication service provider regarding the service.

5. The reward apparatus of claim 4, wherein the RIS node calculates the contribution by quantifying task details of the RIS device related to the instructions of the telecommunication service provider regarding the service.

6. The reward apparatus of claim 5, wherein the at least one program is configured to record the instructions of the telecommunication service provider regarding the service on the first blockchain network and verify the contribution based on the instructions of the telecommunication service provider regarding the service, recorded on the first blockchain network.

7. The reward apparatus of claim 6, wherein the service user terminal quantifies service provision details for the task details of the RIS device, record the quantified service provision details on the first blockchain network, and verifies the contribution based on the service provision details recorded on the first blockchain network.

8. The reward apparatus of claim 1, wherein the RIS device records the reward on a second blockchain network and allows the reward to be verified through RIS nodes participating in the second blockchain network.

9. The reward apparatus of claim 8, wherein:
the first blockchain network verifies a first blockchain transaction related to the contribution, and
the second blockchain network verifies a second blockchain transaction related to the reward.

10. The reward apparatus of claim 9, wherein:
the first blockchain transaction is processed based on a first consensus algorithm of the first blockchain network to which the telecommunication service provider belongs, and
the second blockchain transaction is processed based on a second consensus algorithm of the second blockchain network to which the RIS node belongs.

11. A reward method for blockchain-based Reconfigurable Intelligent Surface (RIS) infrastructure sharing, the reward method being performed by a reward apparatus for blockchain-based RIS infrastructure sharing, the reward method comprising:
providing a service to a service user terminal through an RIS node;
verifying a contribution of the RIS node to provision of the service quantified by the RIS node using a first blockchain network; and
providing a reward to the RIS node depending on the contribution.

12. The reward method of claim 11, wherein verifying the contribution comprises:
calculating, by the RIS node, the contribution by quantifying usage of RIS resources based on quality of a wireless signal for the service and a service usage time, which are received from the service user terminal.

13. The reward method of claim 12, wherein verifying the contribution further comprises:
recording the quality of the wireless signal for the service and the service usage time, which are received from the service user terminal, on the first blockchain network and verifying the contribution based on the quality of the wireless signal and the service usage time, recorded on the first blockchain network.

14. The reward method of claim 11, wherein verifying the contribution comprises:
requesting the RIS node to perform a task of an RIS device in compliance with instructions of a telecommunication service provider regarding the service.

15. The reward method of claim 14, wherein verifying the contribution further comprises:
calculating, by the RIS node, the contribution by quantifying task details of the RIS device related to the instructions of the telecommunication service provider regarding the service.

16. The reward method of claim 15, wherein verifying the contribution further comprises:
recording the instructions of the telecommunication service provider regarding the service on the first blockchain network and verifying the contribution based on the instructions of the telecommunication service provider regarding the service, recorded on the first blockchain network.

17. The reward method of claim 16, wherein verifying the contribution further comprises:
quantifying, by the service user terminal, service provision details for the task details of the RIS device, recording the quantified service provision details on the first blockchain network, and verifying the contribution based on the service provision details recorded on the first blockchain network.

18. The reward method of claim 11, wherein providing the reward comprises:
recording, by the RIS device, the reward on a second blockchain network and allowing the reward to be verified through RIS nodes participating in the second blockchain network.

19. The reward method of claim 18, wherein:
the first blockchain network verifies a first blockchain transaction related to the contribution, and
the second blockchain network verifies a second blockchain transaction related to the reward.

20. The reward method of claim 19, wherein:
the first blockchain transaction is processed based on a first consensus algorithm of the first blockchain network to which the telecommunication service provider belongs, and
the second blockchain transaction is processed based on a second consensus algorithm of the second blockchain network to which the RIS node belongs.
